(19) United States
(12) Patent Application Publication
(10) Pub. No.: US 2026/0215598 A1
(43) Pub. Date: Jul. 30, 2026

(54) INTELLIGENT BEVERAGE REFRIGERATED CABINET WITH AUTOMATIC SORTING AND DIRECTIONAL DISPLAY

(71) Applicant: Ebulent Optronics (Shenzhen) LTD, Shenzhen (CN)

(72) Inventors: LEI DENG, Shenzhen (CN); NING YU, Qingdao (CN)

(21) Appl. No.: 19/576,931

(22) Filed: Mar. 24, 2026

Related U.S. Application Data
(63) Continuation of application No. PCT/CN2025/125005, filed on Sep. 28, 2025.

(30) Foreign Application Priority Data
Sep. 26, 2025 (CN) 202522075575.6

(51) Int. Cl. A47F 3/04; A47F 1/12; A47F 7/28; B07C 5/34; B07C 5/342; G06V 20/68

(52) U.S. Cl. CPC A47F 3/0486; A47F 1/126; A47F 7/28; B07C 5/3404; B07C 5/3422; G06V 20/68

(57) ABSTRACT

Disclosed is an intelligent beverage refrigerated cabinet capable of automatically sorting and directionally displaying a beverage. The cabinet includes multiple layers of track shelves, and a replenishment mechanism pushes the beverage to a front-end display position of a track slot; and A front end of a cabinet body is integrated with a friction-wheel driving mechanism and an image sensor such as a camera or a Contact Image Sensor (CIS), and a bottom of the cabinet body is provided with a low-resistance support tray. When the beverage enters a front row, a switch is triggered, and the image sensor and the friction-wheel driving mechanism are activated in conjunction to drive the beverage to rotate circumferentially for directional display, and a main control module is integrated with a communication function.

### CROSS-REFERENCE TO RELATED APPLICATIONS

This application is a U.S. continuation of co-pending International Patent Application No. PCT/CN2025/125005, filed on 09/28/2025, which claims the benefit and priority of Chinese Patent Application Number 202522075575.6, filed on 09/26/2025, with China National Intellectual Property Administration, the disclosures of which are incorporated herein by reference in their entireties.

### TECHNICAL FIELD

The present invention relates to the technical field of beverage refrigerated cabinets, in particular to an intelligent beverage refrigerated cabinet with automatic sorting and directional display.

### BACKGROUND

Currently, the mainstream beverage vending refrigerated cabinets on the market commonly employ either a “deadweight slide” or a “spring-pushing” mechanism to achieve automatic replenishment. In this arrangement, the beverages are stacked in multiple layers and rows along inclined tracks. When a consumer removes the frontmost beverage, the remaining beverages automatically slide forwards under a force of gravity or spring pressure to fill the vacancy, thereby ensuring that beverages are always present at a front end of a shelf and reducing a frequency of manual replenishment. However, this prior art suffers from a significant and long-unresolved drawback: the vast majority of canned or bottled beverages available on the market are cylindrical and lack any effective physical positioning structures for circumferential orientation. This results in a completely random orientation when the beverages are manually restocked in the refrigerated cabinet, unless an operator spends a considerable amount of time deliberately aligning a front surface of each bottom of beverage (i.e., a brand name, a LOGO, or a main pattern printed on a bottle body or a label of the beverage) to face forwards. During a subsequent automatic forward sliding process, the random orientation is also completely retained and transmitted to the front end. As a result, beverages at a front end of a refrigerated cabinet shelf always appear with front surfaces thereof facing in a disordered and inconsistent manner. To enhance product display, maintain an aesthetically pleasing appearance inside the cabinet, and increase appeal to consumers, operators have to regularly send staff to manually open the cabinet door and rotate each can of beverage to a uniform orientation facing forwards. This work is cumbersome and repetitive, and with the increase of sales, significant labor and time costs are caused.

### SUMMARY

In view of this, the present invention provides an intelligent beverage refrigerated cabinet with automatic sorting and directional display, which can identify label patterns of replenished beverages on display positions for first row of beverages after the refrigerated cabinet is replenished manually, and the beverages are driven to rotate circumferentially by a driving motor, so that front surfaces of the labels of the beverages face forwards.

According to one aspect of the present invention, an intelligent beverage refrigerated cabinet with automatic sorting and directional display is provided, including a cabinet body, a refrigeration system arranged in the cabinet body, a main control module, and multi-layer track shelves, wherein each layer of track shelf includes a plurality of track slots distributed in parallel, beverages are displayed in the track slot, and the track slot is provided with a replenishment mechanism for driving the beverages to push forwards. The cabinet body is provided with an image recognition camera corresponding to an upper side of each layer of track shelf for recognizing a bottle body or label pattern information of the beverage, and a front end position of the track slot is a display position for first row of beverages; the display position of the first row of beverages is provided with a circumferential rotation driving mechanism which includes a friction wheel arranged on a side wall of the track slot and a driving motor connected with the friction wheel, and an outer periphery of the friction wheel protrudes from an inner surface of the side wall and contacts with a side wall of the beverage; and a bottom of the front end of the track slot is provided with a low-friction support tray for bearing the beverage and rotating freely with the beverage synchronously. A rear side of the display position for the first row of beverages of each track slot is provided with a trigger switch for triggering when the beverage is driven into the display position for the first row of beverages by the replenishment mechanism, the trigger switch, the image recognition camera and the driving motor are electrically connected with the main control module, the main control module is integrated with a Wi-Fi, 4G/5G or Ethernet communication module, the image recognition camera and the driving motor are started by triggering the trigger switch to drive the friction wheel of the circumferential rotation driving mechanism to rotate, and the friction wheel drives the beverage on the display position for the first row of beverages to rotate circumferentially.

Aiming at a problem of rotating slippage caused by condensed water on a surface of the beverage, the present invention adopts a solution of combining lateral friction driving with bottom-located rolling resistance reduction. Specifically, rubber friction wheels with high-friction are installed on a side of the display position for first row of beverages, and a forward pressure provided by the replenishment mechanism ensures tight contact between the side wall of the beverage and the friction wheel. Meanwhile, a traditional driving tray is changed into a self-rotating tray supported by a ball bearing. When the lateral friction wheel exerts a force, the bottom support tray only plays the role of bearing and resistance reduction, and converts sliding friction into rolling friction to ensure that power can be transmitted to the bottle body of the beverage without any loss.

Further, the trigger switch is any one of a micro switch, a photoelectric sensor, or a gravity sensor.

Further, the replenishment mechanism is a deadweight sliding mechanism or a spring pushing mechanism.

As a preferred solution of the present invention, a front end of the track slot is provided with a curved resisting side wall, the curved resisting side wall of each track slot is provided with a CIS sensor, each CIS sensor is connected with one image acquisition and processing module, the image acquisition and processing module is correspondingly arranged at a bottom of the track slot, the CIS sensor and the image acquisition and processing module are electrically connected with the main control module, and the CIS sensor is used for acquiring the bottle body or the label pattern information of the beverage on the display position for the first row of beverages of the corresponding track slot.

Further, one side of the curved resisting side wall extend upwards, a bending part bent towards an inner side of the track slot is arranged at an upper end part which extends upwards, and the CIS sensor is arranged at the bending part to collect top image information of the beverage.

Compared with the prior art, the intelligent beverage refrigerated cabinet disclosed by the present invention at least has the following beneficial effects.

1. By arranging the support tray and the circumferential rotation driving mechanism on the front end position of the track slot of the track shelf which uses deadweight slide or spring-pushing mechanism for replenishment, the driving motor can drive the first row of beverages to rotate circumferentially. The image recognition camera is provided to recognize the bottle body or the label pattern information of the first row of beverages on the display position for the first row of beverages in each layer. The main control module pre-stores front surface images of the beverages, an initial point feature of the peripheral rotation of the beverage to the front direction, a circumferential angle of the initial point feature to the front direction, and a number of revolutions converted from the circumferential angle to an output shaft of the driving motor. Therefore, the driving motor is realized to drive the first row of beverages to rotate circumferentially to face forwards, and the first row of beverages in the beverage refrigerated cabinet is automatically and efficiently arranged and displayed with the front surfaces facing forwards, giving consumers a neat and concise visual experience.

2. Aiming at the problem of rotating slippage caused by the condensed water on the surface of the beverage, the solution of combining lateral friction driving with bottom-located rolling resistance reduction is employed. Specifically, the rubber friction wheels with high-friction are installed on the side of the display position for the first row of beverages, and the forward pressure provided by the replenishment mechanism ensures tight contact between the side wall of the beverage and the friction wheel. Meanwhile, the traditional driving tray is changed into the self-rotating tray supported by the ball bearing. When the lateral friction wheel exerts a force, the bottom support tray only plays the role of bearing and resistance reduction, and converts sliding friction into rolling friction to ensure that power can be transmitted to the bottle body of the beverage without any loss.

3. As the main control module is integrated with the Wi-Fi, 4G/5G or Ethernet communication module, the beverage refrigerated cabinet has an intelligent networking function. Data of taking out (selling) beverages can be fed back through the trigger switch and the image recognition camera, which is convenient to realize online real-time monitoring of beverage sales of beverage refrigerated cabinets in different stores, and form automatic statistics to generate sales statistics of different brands of beverages, different stores and different time periods, which is beneficial to stocking the best-selling brand beverages in which store and at which time period, thereby improving sales performance.

4. The CIS sensor (Contact Image Sensor) is arranged at the front end of each track slot, and each CIS sensor is connected with one image acquisition and processing module, so as to recognize the bottle body or label pattern of each first row of beverages, and pre-store different front orientation angle patterns of the first row of beverages corresponding to different track slots for each first row of beverages through the main control module, so that the first row of beverages in different track slots can be independently rotated to the corresponding front orientation angles, and after the front orientation angles of the first row of beverages in the whole refrigerated cabinet are sorted out, the label patterns of beverages in the same layer or the whole refrigerated cabinet can be pieced together into one image, thus improving novel and personalized display effect of the beverages.

### BRIEF DESCRIPTION OF THE DRAWINGS

The drawings incorporated in and constituting a part of the specification illustrate the exemplary embodiments, features and aspects of the present invention together with the specification, and serve to explain the principle of the present invention together with the specification.

FIG. 1 is a schematic diagram of a front surface of an intelligent beverage refrigerated cabinet provided by embodiments of the present invention.

FIG. 2 is a schematic diagram of a side surface of the intelligent beverage refrigerated cabinet provided by the embodiments of the present invention.

FIG. 3 is a schematic diagram of a circumferential rotation driving mechanism provided by the embodiments of the present invention.

FIG. 4 is a schematic diagram showing front surfaces of a first row of beverages in the intelligent beverage refrigerated cabinet provided by the embodiments of the present invention facing forwards uniformly.

FIG. 5 is a schematic diagram showing labels of the first row of beverages in the intelligent beverage refrigerated cabinet provided by the embodiments of the present invention rotating to different angles to form a personalized pattern.

The reference numbers are as follows:

1 - cabinet body; 2 - refrigeration system; 3 - main control module; 4 - image recognition camera; 5 - track shelf; 6 - track slot; 7 - support tray; 8 - circumferential rotation driving mechanism; 8-1 - friction wheel; 8-2 - driving motor; 8-3 - trigger switch; 10 - curved resisting side wall; 11 - CIS sensor; and 01 - first row of beverages.

### DESCRIPTION OF EMBODIMENTS

The following clearly and completely describes the technical solutions in the embodiments of the present invention with reference to the drawings. Apparently, the described embodiments are merely some but not all of the embodiments of the present invention. Based on the embodiments of the present invention, all other embodiments obtained by those of ordinary skills in the art without going through any creative work shall fall within the protection scope of the present invention.

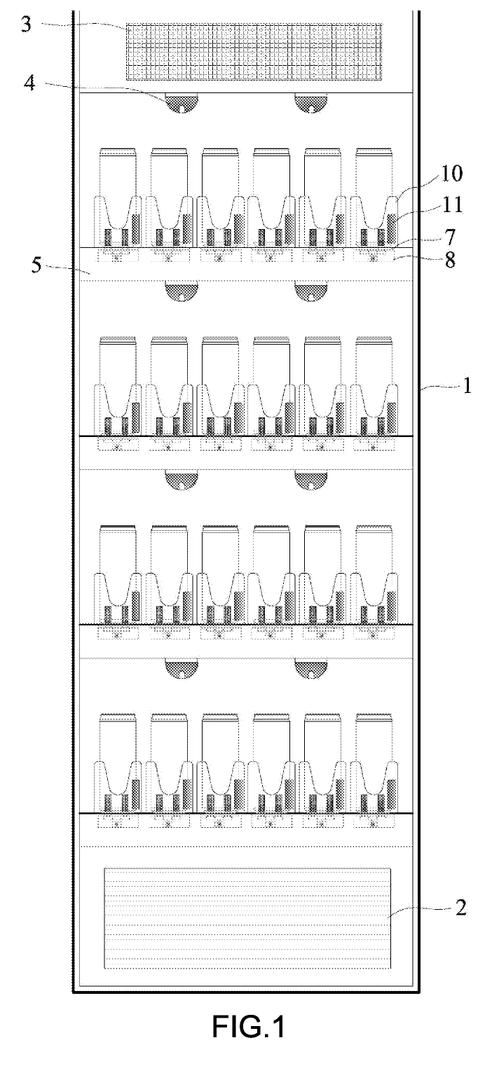

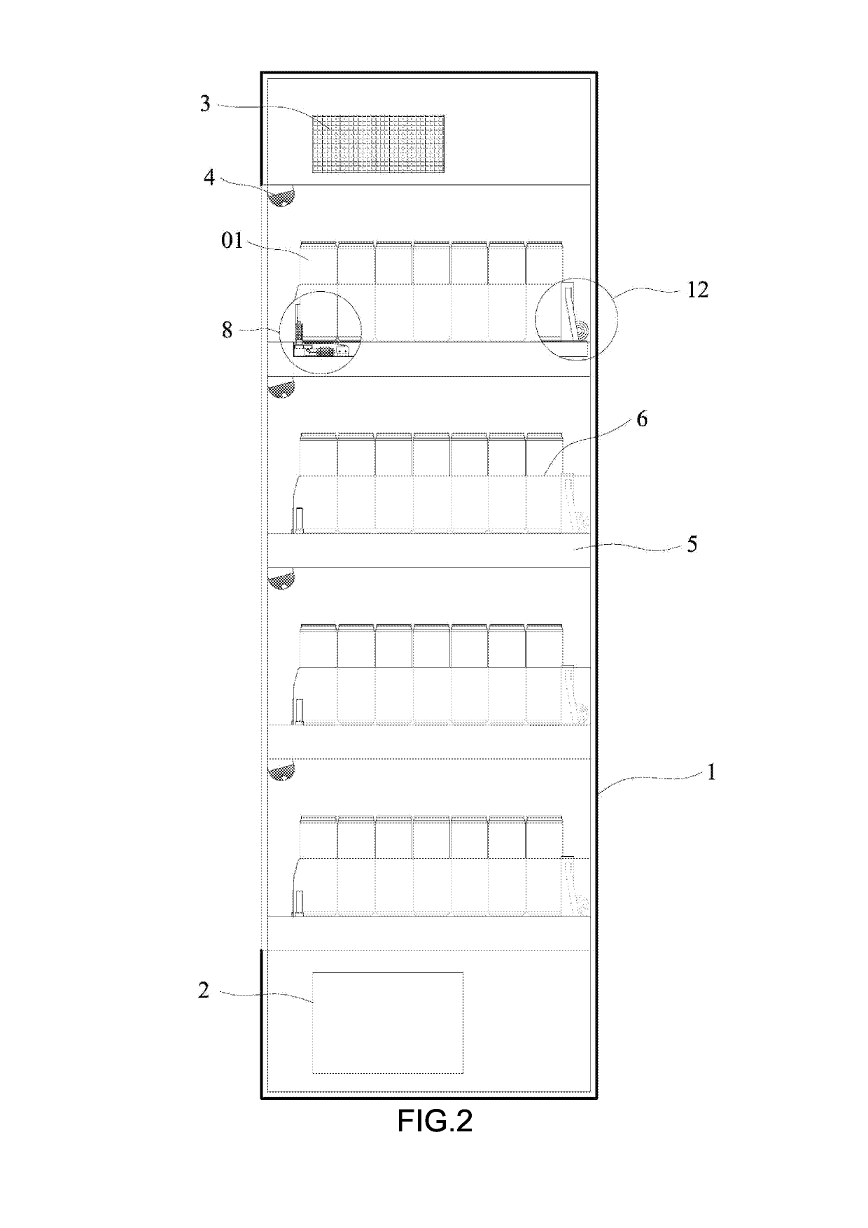

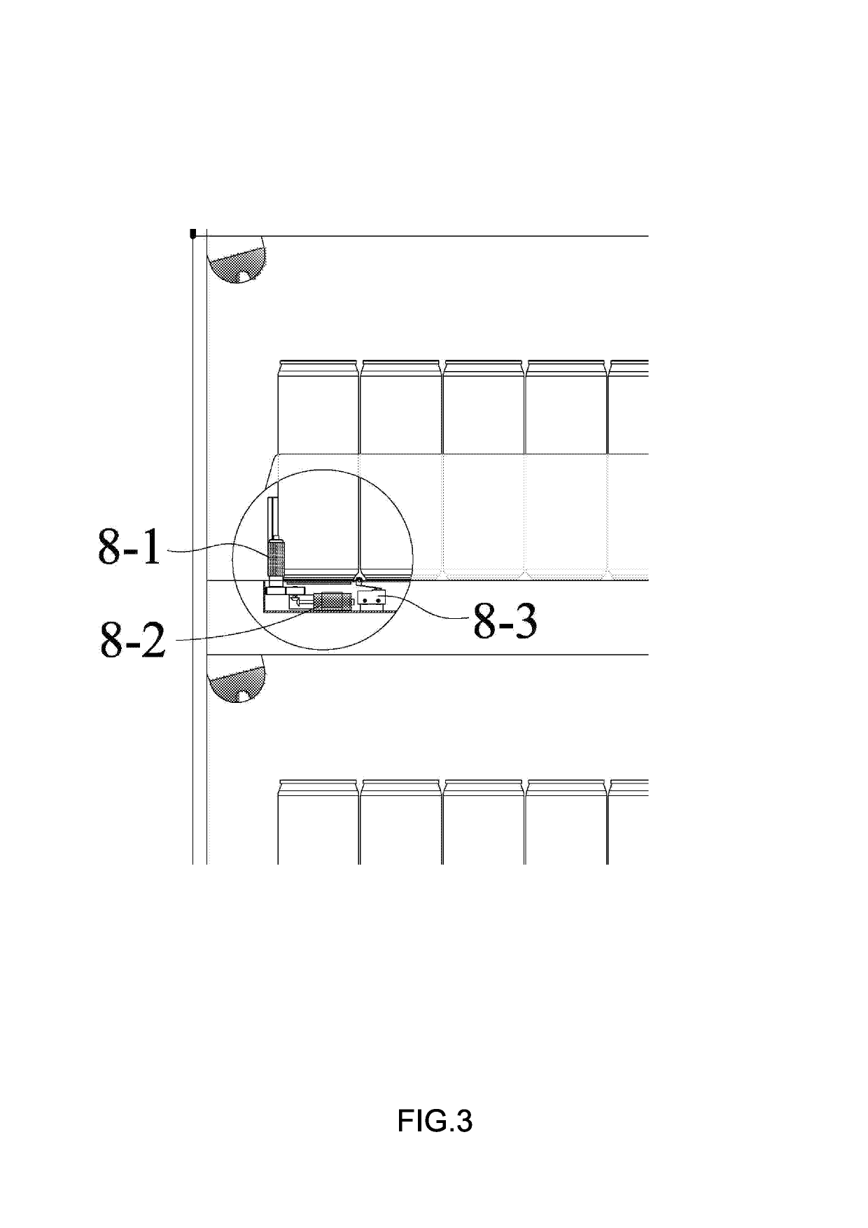

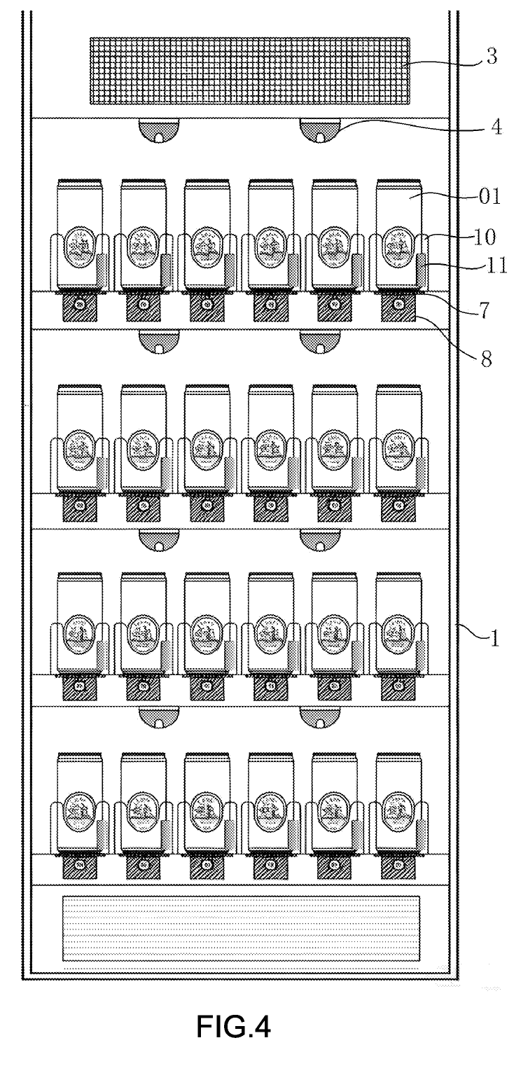

FIG. 1, FIG. 2 and FIG. 3 show a specific embodiment of an intelligent beverage refrigerated cabinet with automatic sorting and directional display disclosed by the solution of the present invention, including a cabinet body 1, a refrigeration system 2 arranged in the cabinet body 1, a main control module 3, and multi-layer track shelves 5, wherein each layer of track shelf 5 includes a plurality of track slots 6 distributed in parallel, beverages are displayed in the track slot 6, and the track slot 6 is provided with a replenishment mechanism for driving the beverages to push forwards. The cabinet body 1 is provided with an image recognition camera 4 corresponding to an upper side of each layer of track shelf 5 for recognizing a bottle body or label pattern information of the beverage, and a front end position of the track slot 6 is a display position for first row of beverages. The display position of the first row of beverages is provided with a support tray 7, and a bottom of the support tray 7 is provided with a circumferential rotation driving mechanism 8. A bottom of the support tray 7 is provided with a ball bearing, so that the support tray can rotate circumferentially with low resistance. A rear side of the display position for the first row of beverages of each track slot 6 is provided with a trigger switch 8-3 for triggering when the beverage is driven into the display position for the first row of beverages by the replenishment mechanism. The trigger switch 8-3, the image recognition camera 4 and a driving motor 8-2 are electrically connected with the main control module 3, the main control module 3 is integrated with a Wi-Fi, 4G/5G or Ethernet communication module, and the image recognition camera 4 and the driving motor 8-2 are started by triggering the trigger switch 8-3 to drive the friction wheel 8-1 to rotate. An outer periphery of the friction wheel 8-1 protrudes from an inner surface of the side wall and contacts with a side wall of the beverage. As the friction wheel 8-1 is in direct contact with a side surface of a beverage 01, and the bottom support tray 7 has almost no rotation resistance due to the ball bearing, the friction wheel 8-1 drives the beverage 01 on the display position for the first row of beverages to rotate circumferentially. Specifically, the main control module 3 pre-stores front surface images of the beverages, an initial point feature of the peripheral rotation of the beverage to the front direction, a circumferential angle of the initial point feature to the front direction, and a number of revolutions converted from the circumferential angle to an output shaft of the driving motor 8-2. In an initial state, after the beverages are placed in all the track slots 6 of the track shelf 5, a control button provided for the main control module 3 is used to start rotation of the first row of beverages 01 on the display position for the first row of beverages, so that the front surfaces of all the beverages face forwards. The initial point feature is any one of a bar code, a two-dimensional code, a specific pattern, a symbol, or a color block on the label of the beverage. Taking the bar code as an example, the circumferential rotation driving mechanism 8 drives the beverage 01 to rotate for one circle, and the image recognition camera 4 stops rotating when recognizing a bar code pattern, and then rotates to the circumferential angle of the front surface of the beverage facing forwards according to a preset bar code pattern position of a MCU unit of the main control module. The circumferential angle is converted into a control program of the number of revolutions of the output shaft of the driving motor 8-2, which is specifically a length parameter developed by the initial point feature and a central axis of the front surface of the beverage. The length parameter is based on a length of the circumferential rotation of the beverage 01 driven by the rotation of the output shaft of the driving motor 8-2, and the number of revolutions required by the output shaft of the driving motor 8-2 is calculated by the MCU unit, so that the circumferential rotation driving mechanism can drive the beverage to rotate circumferentially until the front surface of the beverage faces forwards the front (as shown in FIG. 4).

In the embodiment, the trigger switch 8-3 is any one of a micro switch, a photoelectric sensor, or a gravity sensor. In a process of pushing a second row of beverages to the display position for the first row of beverages through the replenishment mechanism, the second row of beverages passes through the trigger switch 8-3. If a micro switch is used, a metal reed trigger element of the micro switch is triggered by bottoms of the second row of drinks, while a photoelectric sensor is triggered by shielding the second row of beverages when the second row of beverages passes by. A gravity sensor is triggered by an induced weight generated when the second row of beverages passes by.

In the embodiment, the replenishment mechanism is a deadweight sliding mechanism or a spring pushing mechanism. The deadweight slide is composed of a beverage gravity drive and a roller slide, and the roller slide is integrally arranged with a lower front and higher rear, typically at an angle of 3 to 5 degrees, which is a mature technology in the prior art. The spring pushing mechanism is also in the prior art, such as an unpowered cargo passage structure disclosed in the patent authorization announcement number CN223081408U, and this structure may be adopted if the spring pushing mechanism is adopted in the embodiment.

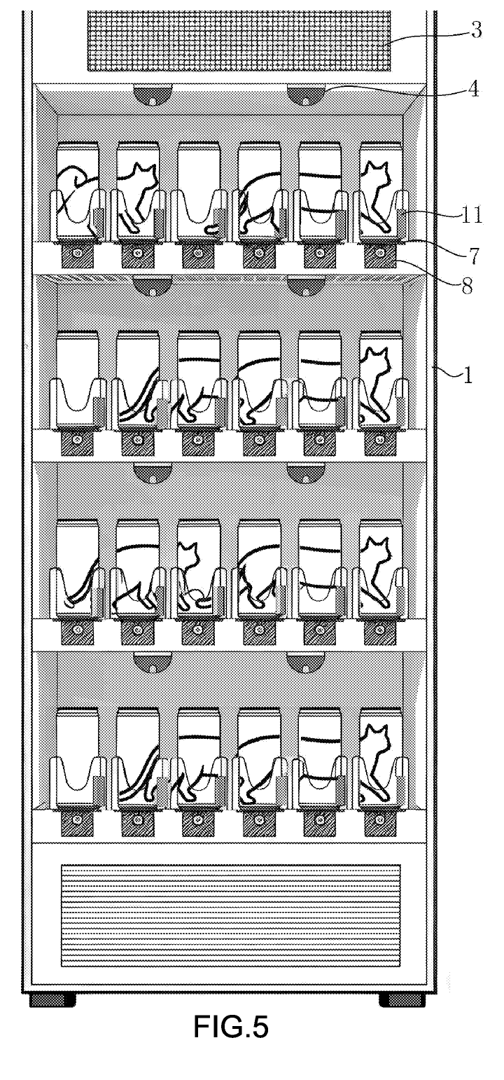

As a preferred solution of the present invention, a front end of the track slot 6 is provided with a curved resisting side wall 10, the curved resisting side wall 10 of each track slot 6 is provided with a CIS sensor 11, each CIS sensor 11 is connected with one image acquisition and processing module, the image acquisition and processing module is correspondingly arranged at a bottom of the track slot 6, the CIS sensor 11 and the image acquisition and processing module are electrically connected with the main control module 3, and the CIS sensor 11 is used for acquiring the bottle body or the label pattern information of the beverage on the display position for the first row of beverages of the corresponding track slot 6, such as a bar code, a two-dimensional code, a specific pattern, a symbol, or a color block on the bottle body or the label of the beverage. As another assembly structure of the CIS sensor 11, one side of the curved resisting side wall 10 extend upwards, a bending part bent towards an inner side of the track slot 6 is arranged at an upper end part which extends upwards, and the CIS sensor 11 is arranged at the bending part to collect top image information of the beverage. For example, a bottle cap of a beverage bottle is provided with a labeled pattern with position recognition feature, which is convenient and quick to recognize. The CIS sensor 11 is arranged at the front end of each track slot , and each CIS sensor 11 is connected with one image acquisition and processing module, so as to recognize the bottle body or label pattern of each first row of beverages 01, and pre-store different front orientation angle patterns of the first row of beverages 01 corresponding to different track slots 6 for each first row of beverages 01 through the main control module 3, so that the first row of beverages 01 in different track slots 6 can be independently rotated to the corresponding front orientation angles, and after the front orientation angles of the first row of beverages 01 in the whole refrigerated cabinet are sorted out, the label patterns of the first row of beverages 01 on the track shelf 5 in the same layer can be pieced together into one personalized pattern (such as FIG. 5). When an inner width of the refrigerated cabinet is wide, a number of rail cars on each track shelf 5 is multiple, such as 20 rows, and a number of layers is 4 to 6, all the first row of beverages 01 in the refrigerated cabinet form 20×4, 20×5 and 20×6 arrays, and the first row of beverages 01 in different positions are rotated to a certain angle, so that the patterns of the bottle bodies or the label patterns of all the first row of beverages 01 in the whole refrigerated cabinet are pieced together into one personalized pattern to improve the novel and personalized display effect of the beverages. In the embodiment, the patterns on the labels of the beverages presented in FIG. 4 and FIG. 5 are provided for illustrative purposes only and do not constitute a limitation on the patterns.

For the specific structural implementation of the track slot 6, please refer to an automatic rotating device for displayed goods based on a CIS module disclosed in the patent authorization announcement number CN221884377U. Based on this solution, the technical solution of the embodiment is additionally provided with the image recognition camera 4 arranged on the upper side of the track shelf 5 of the cabinet body 1 of the refrigerated cabinet, and the main control module 3 is integrated with the Wi-Fi, 4G/5G or Ethernet communication module, so as to realize the unified display of the first row of beverages 01 in the refrigerated cabinet with the front surfaces of the first row of beverages facing forwards, and also to independently rotate the first row of beverages 01 in each track slot 6 to an orientation angle. Therefore, the label patterns of beverages on the same layer are spliced into one personalized pattern, or the label patterns of the first row of beverages 01 of all the track slots 6 on the multiple layers of track shelves 5 in the whole refrigerated cabinet are spliced into one personalized pattern. Meanwhile, the main control module 3 is integrated with the Wi-Fi, 4G/5G or Ethernet communication module, the beverage refrigerated cabinet has an intelligent networking function. Data of taking out (selling) beverages can be fed back through the trigger switch 8-3 and the image recognition camera 4, which is convenient to realize online real-time monitoring of beverage sales of beverage refrigerated cabinets in different stores, and form automatic statistics to generate sales statistics of different brands of beverages, different stores and different time periods, which is beneficial to stocking the best-selling brand beverages in which store and at which time period, thereby improving sales performance.

In the embodiment, the driving motor 8-2 is a stepping motor or a servo motor, and the main control module 3 uses an existing PLC control system to control each driving motor 8-2. The PLC control system is a mature technology in the prior art, and is not detailed here.

The parts not described in detail in the technical solution specification are obvious to those skilled in the art and may be supplemented and improved according to the prior art knowledge. Meanwhile, it should be understood by those of ordinary skills in the art that the above embodiments are merely preferred embodiments of the present invention. Those of ordinary skills in the art may also make a plurality of improvements and decorations without departing from the principle of the present invention, and these improvements and decorations shall also fall within the protection scope of the present invention.

What is claimed is:

1. An intelligent beverage refrigerated cabinet with automatic sorting and directional display, comprising a cabinet body, a refrigeration system arranged in the cabinet body, a main control module, and multi-layer track shelves, wherein each layer of track shelf comprises a plurality of track slots distributed in parallel, beverages are displayed in the track slot, and the track slot is provided with a replenishment mechanism for driving the beverages to push forwards, wherein,
the cabinet body is provided with an image recognition camera corresponding to an upper side of each layer of track shelf for recognizing a bottle body or label pattern information of the beverage, and a front end position of the track slot is a display position for first row of beverages,
the display position of the first row of beverages is provided with a circumferential rotation driving mechanism which comprises a friction wheel arranged on a side wall of the track slot and a driving motor connected with the friction wheel, and an outer periphery of the friction wheel protrudes from an inner surface of the side wall and contacts with a side wall of the beverage; and a bottom of the front end of the track slot is provided with a low-friction support tray for bearing the beverage and rotating freely with the beverage synchronously, and
a rear side of the display position for the first row of beverages of each track slot is provided with a trigger switch for triggering when the beverage is driven into the display position for the first row of beverages by the replenishment mechanism, the trigger switch, the image recognition camera and the driving motor are electrically connected with the main control module, the main control module is integrated with a Wi-Fi, 4G/5G or Ethernet communication module, the image recognition camera and the driving motor are started by triggering the trigger switch to drive the friction wheel of the circumferential rotation driving mechanism to rotate, and the friction wheel drives the beverage on the display position for the first row of beverages to rotate circumferentially.

2. The intelligent beverage refrigerated cabinet with automatic sorting and directional display according to claim 1, wherein the low-friction support tray comprises a base fixed at a bottom of the track and a rotating tray mounted on the base through a plane ball bearing.

3. The intelligent beverage refrigerated cabinet with automatic sorting and directional display according to claim 1, wherein the driving motor is horizontally arranged below the track slot and drives a vertically arranged friction wheel rotating shaft through a bevel gear set or a synchronous belt.

4. The intelligent beverage refrigerated cabinet with automatic sorting and directional display according to claim 1, wherein the trigger switch is any one of a micro switch, a photoelectric sensor, or a gravity sensor.

5. The intelligent beverage refrigerated cabinet with automatic sorting and directional display according to claim 1, wherein the replenishment mechanism is a deadweight sliding mechanism or a spring pushing mechanism.

6. The intelligent beverage refrigerated cabinet with automatic sorting and directional display according to claim 1, wherein a front end of the track slot is provided with a curved resisting side wall, the curved resisting side wall of each track slot is provided with a CIS sensor, each CIS sensor is connected with one image acquisition and processing module, the image acquisition and processing module is correspondingly arranged at a bottom of the track slot, the CIS sensor and the image acquisition and processing module are electrically connected with the main control module, and the CIS sensor is used for acquiring the bottle body or the label pattern information of the beverage on the display position for the first row of beverages of the corresponding track slot.

7. The intelligent beverage refrigerated cabinet with automatic sorting and directional display according to claim 6, wherein one side of the curved resisting side wall extend upwards, a bending part bent towards an inner side of the track slot is arranged at an upper end part which extends upwards, and the CIS sensor is arranged at the bending part to collect top image information of the beverage.
